(19) United States
(12) Patent Application Publication
(10) Pub. No.: US 2026/0102961 A1
(43) Pub. Date: Apr. 16, 2026

(54) TUBULAR-MOLDED-BODY PRODUCTION METHOD AND TUBULAR-MOLDED-BODY PRODUCTION DEVICE

(71) Applicant: KANEKA CORPORATION, Osaka (JP)

(72) Inventor: Kengo Fukushima, Osaka (JP)

(73) Assignee: KANEKA CORPORATION, Osaka (JP)

(21) Appl. No.: 19/252,507

(22) Filed: Jun. 27, 2025

(30) Foreign Application Priority Data
Jun. 28, 2024 (JP) 2024-105310

(51) Int. Cl. B29C 48/88; B29C 48/00; B29C 48/09; B29K 67/00

(52) U.S. Cl. CPC B29C 48/9115; B29C 48/022; B29C 48/09; B29C 48/919; B29K 2067/04

(57) ABSTRACT

In order to suppress unsteady movement of a molten resin tube in a preliminary water tank in a preceding stage of a vacuum water tank and to improve stability of continuous extrusion of the molten resin tube, in a tubular-molded-body production method, a cooling step includes the steps of: introducing a molten resin tube (P) into a preliminary water tank (20) to which cooling water is continuously supplied and then into a vacuum water tank (30) which is connected to the preliminary water tank (20), and suppressing, with use of a jig (40), direct hit of a flow of the cooling water on the molten resin tube (P) by installing the jig (40) in the preliminary water tank (20).

This Nonprovisional application claims priority under 35 U.S.C. § 119 on Patent Application No. 2024-105310 filed in Japan on Jun. 28, 2024, the entire contents of which are hereby incorporated by reference.

### TECHNICAL FIELD

The present invention relates to a tubular-molded-body production method and a tubular-molded-body production device.

### BACKGROUND ART

Patent Literature 1 discloses a technique in which in extrusion molding, in cooling a molten resin tube that is obtained by extrusion of a molten resin composition from a die, the molten resin tube is introduced into a preliminary water tank and a vacuum water tank that is connected to the preliminary water tank. In the vicinity of an inlet of the vacuum water tank, a sizing die is set. In the technique of Patent Literature 1, since cooling water in the preliminary water tank and the molten resin tube are sucked into the vacuum water tank, it is possible to obtain a sizing effect of improving a degree of true circle of the molten resin tube by the sizing die that is set in the vicinity of the inlet of the water tank.

According to the technique of Patent Literature 1, in the preliminary water tank, a direction in which the cooling water is supplied is along the same axis as an extrusion direction of the molten resin composition and in an opposite direction from the extrusion direction of the molten resin composition. With this configuration, a flow of the cooling water does not directly hit the molten resin tube extruded. Thus, in the preliminary water tank in a preceding stage of the vacuum water tank, unsteady movement of the molten resin tube due to the flow of the cooling water is prevented.

### CITATION LIST

### Patent Literature

### [Patent Literature 1]

Japanese Patent Application Publication Tokukai No. 2009-97580

### SUMMARY OF INVENTION

### Technical Problem

However, only setting the direction of the flow of the cooling water in the preliminary water tank as in the technique of Patent Literature 1 is not enough to prevent the unsteady movement of the molten resin tube. For example, in a case where an inflow amount of the cooling water is large, the molten resin tube may unsteadily move due to the occurrence of turbulent flow of the cooling water. Further, a large amount of the cooling water is supplied to the preliminary water tank. Accordingly, in a case where the direction in which the cooling water is supplied is along the same axis as the extrusion direction of the molten resin composition and in an opposite direction from the extrusion direction of the molten resin composition, the cooling water hits a wall on an inlet side or outlet side of the preliminary water tank and the cooling water that springs back hits the molten resin tube. This may result in unsteady movement of the molten resin tube. In a case where the molten resin tube unsteadily moves in the preliminary water tank, stability of continuous extrusion of the molten resin tube deteriorates.

An object of an aspect of the present invention is to provide a tubular-molded-body production method and a tubular-molded-body production device which can suppress unsteady movement of a molten resin tube in a preliminary water tank in a preceding stage of a vacuum water tank and thus can improve stability of continuous extrusion of the molten resin tube.

### Solution to Problem

In order to solve the above problems, a tubular-molded-body production method in accordance with an aspect of the present invention includes the steps of: extruding a molten resin composition from an annular die and forming a molten resin tube; and cooling the molten resin tube, the step of cooling including the steps of: introducing the molten resin tube into a preliminary water tank to which cooling water is continuously supplied and then into a vacuum water tank which is connected to the preliminary water tank, and suppressing, with use of a jig, direct hit of a flow of the cooling water on the molten resin tube by installing the jig in the preliminary water tank.

In order to solve the above problems, a tubular-molded-body production device in accordance with an aspect of the present invention includes: an extrusion section that has an annular die for extruding a molten resin composition into a tubular shape; and a cooling section that cools the molten resin tube extruded from the annular die, the cooling section including a preliminary water tank and a vacuum water tank connected to the preliminary water tank, and being configured such that the molten resin tube is introduced into the preliminary water tank and then into the vacuum water tank, the preliminary water tank including a supply section that continuously supplies cooling water into the preliminary water tank, and the preliminary water tank being provided therein a jig, and suppressing, with use of the jig, direct hit of a flow of the cooling water from the supply section on the molten resin tube.

### Advantageous Effects of Invention

An aspect of the present invention can suppress unsteady movement of a molten resin tube in a preliminary water tank in a preceding stage of a vacuum water tank and thus can improve stability of continuous extrusion of the molten resin tube.

### BRIEF DESCRIPTION OF DRAWINGS

FIG. 1 is a cross sectional view illustrating a prerequisite configuration of a tubular-molded-body production device in accordance with an embodiment of the present invention.

FIG. 2 includes drawings for illustrating unsteady movement of a molten resin tube in a preliminary water tank in the production device which has the prerequisite configuration illustrated in FIG. 1, and the reference sign 201 indicates a cross sectional view taken along a direction orthogonal to a height direction and the reference sign 202 indicates a cross sectional view taken along a direction orthogonal to a length direction.

FIG. 3 is a perspective view illustrating an example of a jig that is provided in the tubular-molded-body production device in accordance with the embodiment of the present invention.

FIG. 4 is a cross sectional view that is taken along the direction orthogonal to the height direction and that is for illustrating an unsteady movement suppression effect for a molten resin tube P which is brought about by the jig 40 illustrated in FIG. 3.

FIG. 5 is a cross sectional view that is taken along the direction orthogonal to the length direction and that is for illustrating the unsteady movement suppression effect for the molten resin tube P which is brought about by the jig 40 illustrated in FIG. 3.

FIG. 6 is a perspective view for illustrating the unsteady movement suppression effect for the molten resin tube P which is brought about by the jig 40 illustrated in FIG. 3.

### DESCRIPTION OF EMBODIMENTS

The following description will discuss an embodiment of the present invention in detail. Note that in the present specification, the wording “A to B” indicative of a numerical range means “A or more and B or less” unless otherwise specifically mentioned. In addition, all of the literatures listed herein are incorporated by reference herein.

### Embodiment 1

The following description will discuss an embodiment of the present invention.

(Tubular-Molded-Body Production Device in Accordance with Present Embodiment)

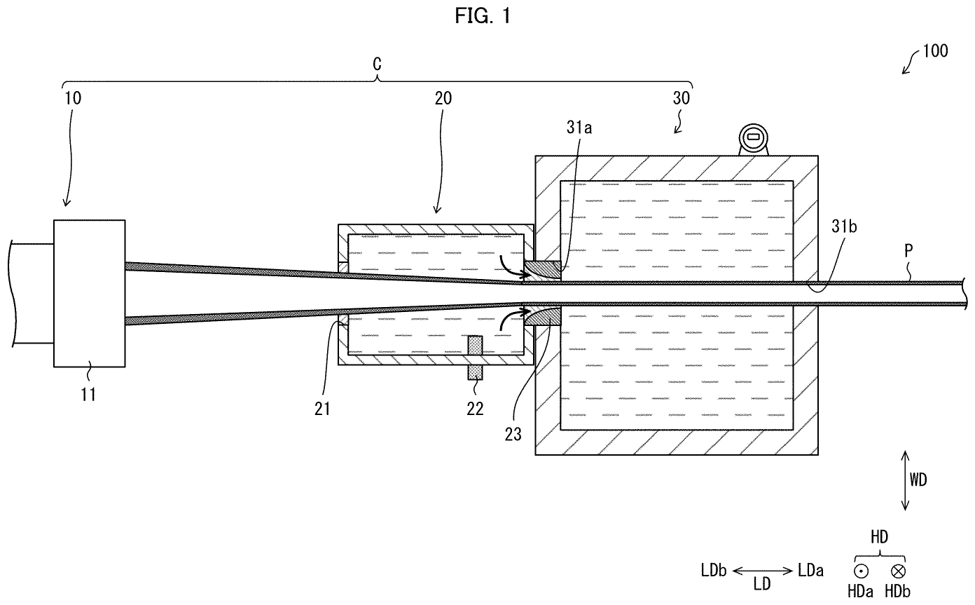

FIG. 1 is a cross sectional view illustrating a prerequisite configuration of a tubular-molded-body production device 100 in accordance with the present embodiment.

As illustrated in FIG. 1, as a prerequisite configuration, the production device 100 includes: a melt extruder 10 (extrusion section) for extruding a molten resin tube P; and a cooling section C. The molten resin tube P extruded from the melt extruder 10 moves to the cooling section C. The cooling section C cools the molten resin tube P extruded from the melt extruder 10. As a result of cooling the molten resin tube P in the cooling section C, the molten resin tube P becomes a tubular molded body.

Note that as described in FIG. 1, in the present specification, a length direction (axial direction) of the molten resin tube P is referred to as an LD direction, one side (front side) in the LD direction is referred to as an LDa side, and the other side (rear side) in the LD direction is referred to as an LDb side. Further, a direction (height direction) orthogonal to a horizontal plane in the LD direction is referred to as an HD direction, and one side (upper side) in the HD direction is referred to as an HDa side, and the other side (lower side) in the HD direction is referred to as an HDb side. Further, a direction (width direction) orthogonal to both of the LD direction and the HD direction are referred to as a WD direction.

In the production device 100, the LD direction corresponds to an extrusion direction of the molten resin tube P. The LDb side corresponds to an upstream side in the extrusion direction of the molten resin tube P, and the LDa side corresponds to a downstream side in the extrusion direction. In other words, in the production device 100, the molten resin tube P extruded from the melt extruder 10 moves from the LDb side to the LDa side.

The melt extruder 10 melts and kneads a resin composition and produces a molten resin composition. The melt extruder 10 can be a conventionally known melt extruder provided that the conventionally known melt extruder can melt and knead a resin composition and produce a molten resin composition. The melt extruder 10 has an annular die 11 for extruding the molten resin composition in a tubular shape. As a result of extrusion through the annular die 11, the molten resin composition has a tubular shape and the molten resin tube P can be obtained. Note that the annular die 11 is attached to an end on the HDa side of the melt extruder 10.

The cooling section C includes a preliminary water tank 20, and a vacuum water tank (reduced pressure water tank) 30 that is connected to the preliminary water tank 20. The cooling section C is configured such that the molten resin tube P is introduced into the preliminary water tank 20 and then into the vacuum water tank 30. In the cooling section C, the preliminary water tank 20 is connected to an inlet 31a on the LDb side of the vacuum water tank 30.

The preliminary water tank 20 preliminarily cools the molten resin tube P before the molten resin tube P is sucked in the vacuum water tank 30. The preliminary water tank 20 has an inlet 21 on the LDb side. The molten resin tube P is introduced into the preliminary water tank 20 via the inlet 21. Further, the preliminary water tank 20 includes a supply section 22. The supply section 22 continuously supplies cooling water into the preliminary water tank 20. The supply section 22 is provided on a wall portion of the preliminary water tank 20 on one side in the WD direction. The supply section 22 is configured to discharge the cooling water into the preliminary water tank 20. A direction (discharge direction) in which the cooling water is supplied by the supply section 22 is different from the LD direction and is the WD direction. Accordingly, a flow of the cooling water in the WD direction occurs in the preliminary water tank 20 due to supply of the cooling water by the supply section 22.

Further, the preliminary water tank 20 includes a sizing die 23. The sizing die 23 is provided on a connecting part between the preliminary water tank 20 and the inlet 31a of the vacuum water tank 30. The preliminary water tank 20 and the vacuum water tank 30 communicate with each other via the sizing die 23. Accordingly, the molten resin tube P and the cooling water in the preliminary water tank 20 are vacuum-suctioned from the sizing die 23 and flows into the vacuum water tank 30. Accordingly, a flow of the cooling water toward the sizing die 23 in addition to the flow of the cooling water which is caused by the supply section 22 occurs in the preliminary water tank 20.

The vacuum water tank 30 is for further cooling and solidifying the molten resin tube P which is preliminarily cooled by the preliminary water tank 20. The cooling water is accommodated in the vacuum water tank 30 to an extent that the molten resin tube P is immersed in the cooling water. Then, the vacuum water tank 30 includes a vacuum pump (not shown) that sucks only air. This vacuum pump causes the inside of the vacuum water tank 30 to be in a vacuum (reduced pressure) state.

In the production device 100, the molten resin tube P extruded from the annular die 11 is preliminarily cooled in the preliminary water tank 20. Then, the molten resin tube P together with the cooling water in the preliminary water tank 20 is introduced into the vacuum water tank 30 from the inlet 31a by vacuum suction and is discharged from an outlet 31b. When the molten resin tube P is introduced into the vacuum water tank 30 by vacuum suction, the molten resin tube P is subjected to sizing by the sizing die 23 such that a bore diameter of the molten resin tube P is reduced. This leads to improvement of a degree of true circle of the molten resin tube P (sizing effect).

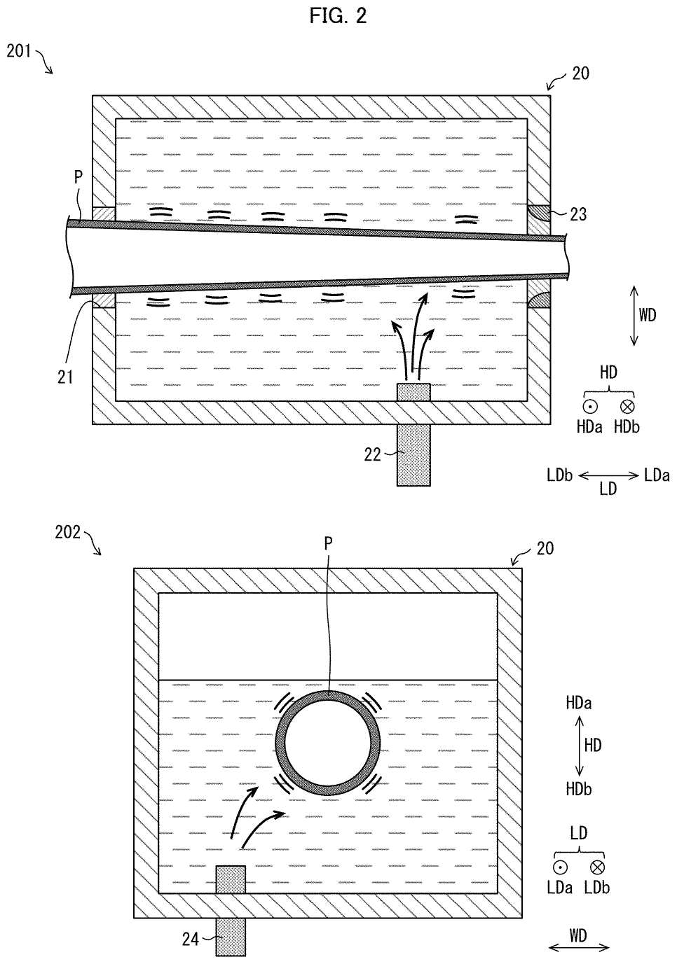

FIG. 2 includes drawings for illustrating unsteady movement of the molten resin tube P in the preliminary water tank 20 in the production device 100 which has the prerequisite configuration illustrated in FIG. 1. The reference sign 201 of FIG. 2 indicates a cross sectional view taken along a direction orthogonal to the HD direction and the reference sign 202 of FIG. 2 indicates a cross sectional view taken along a direction orthogonal to the LD direction.

As illustrated in 201 of FIG. 2, a direction (discharge direction) in which the cooling water is supplied by the supply section 22 is different from the LD direction and is the WD direction. Further, a large amount of the cooling water is supplied from the supply section 22 to the preliminary water tank 20 for preliminary cooling of the molten resin tube P. Accordingly, the flow of the cooling water from the supply section 22 directly hits the molten resin tube P extruded in the LD direction in the preliminary water tank 20, and the molten resin tube P unsteadily moves in the WD direction.

As illustrated in 202 of FIG. 2, in the production device 100 which has the prerequisite configuration, the preliminary water tank 20 may include a supply section 24 in addition to the supply section 22. The supply section 24 is provided on a lower surface (surface on the HDb side) of the preliminary water tank 20 and is configured to discharge the cooling water from the HDb side to the HDa side. In the configuration indicated by 202 of FIG. 2, a direction (discharge direction) in which the cooling water is supplied by the supply section 24 is the HD direction. In the configuration indicated by 202 in FIG. 2, the flow of the cooling water from the supply section 24 directly hits the molten resin tube P extruded in the LD direction in the preliminary water tank 20, and the molten resin tube P unsteadily moves in the HD direction.

In a case where the molten resin tube P unsteadily moves as described above, stability of continuous extrusion of the molten resin tube P deteriorates. Further, a position where the molten resin tube P enters the sizing die 23 is unstable, so that the sizing effect of the molten resin tube P is deteriorated.

In light of the above, the production device 100 in accordance with the present embodiment is configured such that: a jig is installed in the preliminary water tank 20; and the jig is used to suppress direct hit of the flow of the cooling water from the supply section 22 or 24 on the molten resin tube P. This configuration can prevent unsteady movement of the molten resin tube P in the preliminary water tank 20, so that the stability of continuous extrusion of the molten resin tube P is improved. Further, according to the above-described configuration, the position where the molten resin tube P enters the sizing die 23 becomes stable, so that the sizing effect of the molten resin tube P is improved.

Note that in the production device 100 in accordance with the present embodiment, the jig only needs to be configured such that: the jig can be installed in the preliminary water tank 20; and the jig prevents direct hit of the flow in directions other than the LD direction of the cooling water on the molten resin tube P. Thus, the jig can be designed, as appropriate, in accordance with a direction of the flow of the cooling water. The jig only needs to have a wall portion that receives the flow of the cooling water.

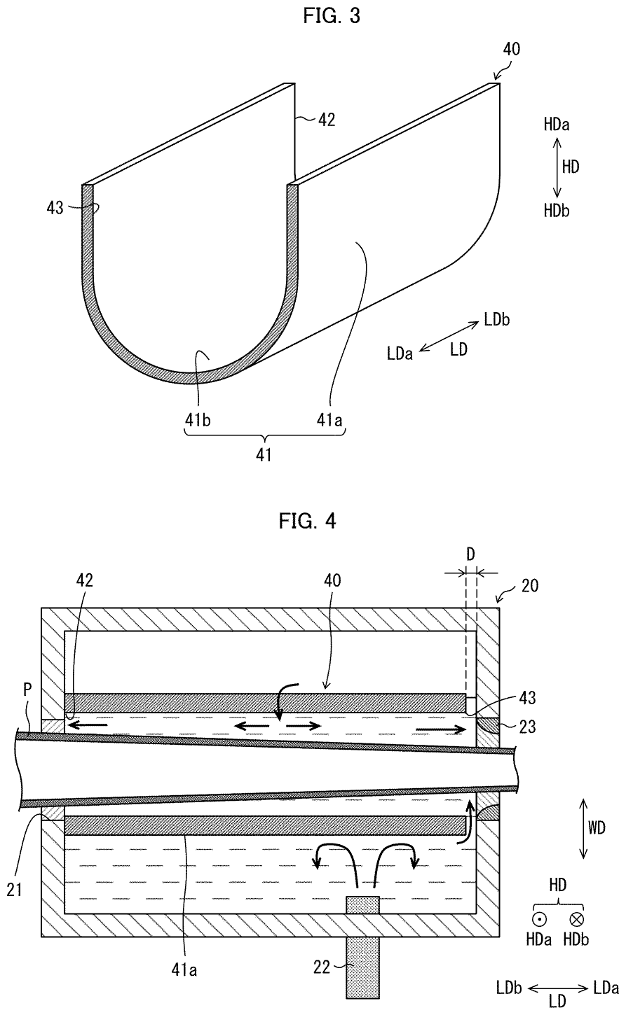

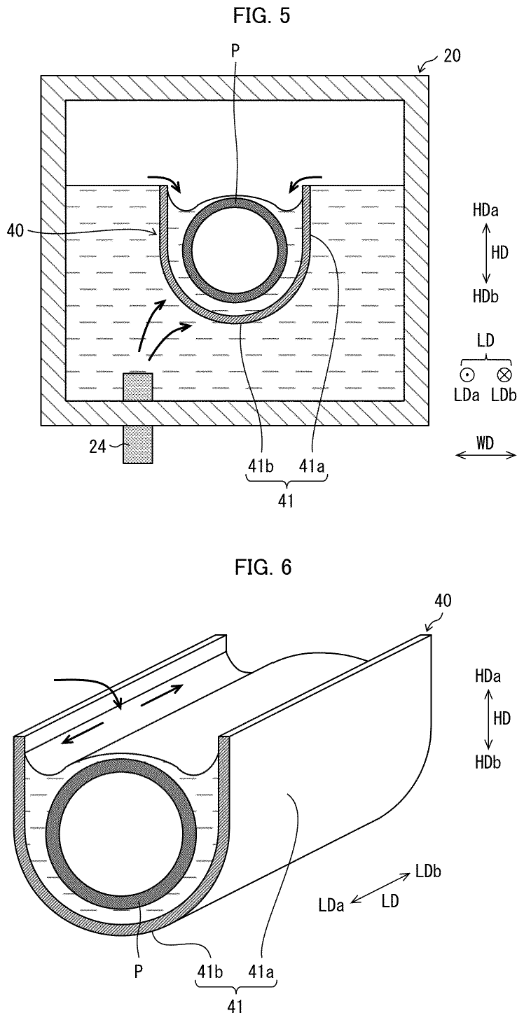

FIG. 3 is a perspective view illustrating an example of the jig 40 that is provided in the production device 100 in accordance with the present embodiment. Further, FIGS. 4 to 6 are each a diagram for illustrating an unsteady movement suppression effect for the molten resin tube P which is brought about by the jig 40 illustrated in FIG. 3. FIG. 4 is a cross sectional view taken along the direction orthogonal to the HD direction. FIG. 5 is a cross sectional view taken along the direction orthogonal to the LD direction. FIG. 6 is a perspective view.

As illustrated in FIG. 3, the jig 40 has a passage part 41. The passage part 41 has two side wall portions 41a and a bottom wall portion 41b. The bottom wall portion 41b connects between the two side wall portions 41a. The passage part 41 constitutes, with use of the two side wall portions 41a and the bottom wall portion 41b, a groove which has a U-shaped cross section, which extends in the LD direction, and which is opened on the HDa side. The jig 40 has, for example, a trough shape for the passage part 41.

As illustrated in FIGS. 4 and 5, in the jig 40, the passage part 41 is a passage for guiding the molten resin tube P to the vacuum water tank. In other words, in the preliminary water tank 20, the jig 40 is installed such that the molten resin tube P is accommodated in the passage part 41. Further, a length of the jig 40 in the LD direction is smaller than an interval between two inner wall surfaces that are opposed to each other in the LD direction of the preliminary water tank 20. Then, as illustrated in FIG. 4, the jig 40 is disposed such that an inlet on the LDb side of the passage part 41 is in contact with the inlet 21 of the preliminary water tank 20. Accordingly, a gap D occurs between the passage part 41 of the jig 40 and the inner wall surface on the LDa side of the preliminary water tank 20.

Next, the following description will discuss the unsteady movement suppression effect for the molten resin tube P which is brought about by the jig 40. Note that in FIGS. 4 to 6, an arrow indicates the flow of the cooling water in the preliminary water tank 20. As illustrated in FIG. 4, the side wall portion 41a receives the flow of the cooling water from the supply section 22. This suppresses direct hit of the flow of the cooling water from the supply section 22 on the molten resin tube P. Further, as illustrated in FIG. 5, the bottom wall portion 41b receives the flow of the cooling water from the supply section 24. This suppresses direct hit of the flow of the cooling water from the supply section 24 on the molten resin tube P.

As described above, according to the present embodiment, the jig 40 is disposed such that the molten resin tube P is accommodated in the passage part 41. Accordingly, it is possible to suppress direct hit of the flow of the cooling water from the supply sections 22 and 24 on the molten resin tube P. Further, this can prevent unsteady movement of the molten resin tube P in the preliminary water tank 20, so that the stability of continuous extrusion of the molten resin tube P is improved. Further, the position where the molten resin tube P enters the sizing die 23 is stabilized, and thus the sizing effect of the molten resin tube P is improved.

Furthermore, the cooling water supplied to the preliminary water tank 20 flows into the passage part 41 and cools the molten resin tube P. Such cooling water indirectly hits the molten resin tube P, but does not influence unsteady movement of the molten resin tube P. Specifically, the cooling water from the supply sections 22 and 24 flows into the passage part 41 of the jig 40 via the gap D and indirectly hits the molten resin tube P. Further, since a large amount of the cooling water is supplied to the preliminary water tank 20, the cooling water flows into the passage part 41 beyond an end face (upper surface) on the HDa side of the passage part 41 and indirectly hits the molten resin tube P. The cooling water that has flowed into the passage part 41 in this way is influenced by vacuum suction by the vacuum water tank. Therefore, since the direction of the flow of the cooling water is substantially in the LD direction, the cooling water does not influence unsteady movement of the molten resin tube P.

Further, the preliminary water tank 20 only needs to include at least one of the supply sections 22 and 24. For example, in a case where the preliminary water tank 20 includes only the supply section 22, there may be a case where influence of the cooling water directly hitting the molten resin tube P from the HDb is small. In such a case, the passage part 41 of the jig 40 may not include the bottom wall portion 41b. However, even in a case where the preliminary water tank 20 includes only the supply section 22, the passage part 41 preferably includes the bottom wall portion 41b, from the viewpoint of reducing the influence of the cooling water directly hitting the molten resin tube P.

Further, the cooling water in the preliminary water tank 20 flows into the passage part 41, and the molten resin tube P that is accommodated in the passage part 41 is preliminarily cooled. The passage part 41 is not limited to the configuration illustrated in FIGS. 3 to 6 provided that the passing part 41 has a configuration that allows the cooling water to flow in the passage part 41. For example, the passage part 41 may be configured such that the HDa side is opened and the gap D is not formed. Alternatively, the passage part 41 may be configured such that the HDa side is closed by an upper wall portion and the gap D is formed.

(Tubular-Molded-Body Production Method in Accordance with Present Embodiment)

A tubular-molded-body production method in accordance with the present embodiment includes an extrusion step and a cooling step. The extrusion step is the step of extruding a molten resin composition from an annular die to form a molten resin tube, and the cooling step is the step of cooling the molten resin tube. In the tubular-molded-body production method in accordance with the present embodiment, the cooling step includes an introduction step and a suppression step. The introduction step is the step of introducing the molten resin tube into a preliminary water tank to which cooling water is continuously supplied and then into a vacuum water tank which is connected to the preliminary water tank. The suppression step is the step of suppressing, with use of a jig, direct hit of a flow of the cooling water on the molten resin tube by installing the jig in the preliminary water tank.

The tubular-molded-body production method in accordance with the present embodiment is not particularly limited as long as the method includes the extrusion step and the cooling step and the cooling step includes the introduction step and the suppression step. For example, the tubular-molded-body production method in accordance with the present embodiment includes a method using the tubular-molded-body production device 100 described above. The following description will discuss various steps of the tubular-molded-body production method in accordance with the embodiment, taking, as an example, a method using the production device 100 as an example.

First, in the extrusion step, the molten resin composition is extruded from the annular die 11, and a molten resin tube P is formed. In this extrusion step, a resin composition is melted and kneaded by the melt extruder 10 and moved to the annular die 11, and a resulting molten resin composition is extruded from the annular die 11.

An aspect of melting and kneading the resin composition by the melt extruder 10 is not particularly limited, provided that it is possible to obtain a melted and kneaded resin composition. Specific examples of a method of melting and kneading include the following (a1) and (a2):
(a1) a method according to which: a resin composition containing a thermoplastic resin is prepared by mixing or blending with use of a mixing device or the like; and thereafter, the resin composition is supplied to the melt extruder 10 and melted and kneaded; and
(a2) a method according to which: raw materials of a resin composition that contains a thermoplastic resin is supplied to the melt extruder 10, and the resin composition is prepared (completed) in the melt extruder 10 and at the same time, the resin composition is melted and kneaded.

In the method of (a1), the order of mixing or blending (dry blending) raw materials of the resin composition is not particularly limited. In the method of (a2), the order in which the raw materials of the resin composition is supplied to the melt extruder 10 is not particularly limited.

In the method of (a1), the mixing device is not particularly limited and examples of the mixing device include a ribbon blender, a flush blender, a tumbler mixer, and a super mixer.

In the above methods of (a1) and (a2), examples of the melt kneading device include, in addition to the melt extruder 10, a kneader, a Banbury mixer, and a roller. The melting and kneading device is preferably the melt extruder 10 because the melt extruder 10 has excellent productivity and excellent convenience. Further, the melt extruder 10 is preferably a biaxial extruder.

It is not possible to unconditionally specify a temperature at the time of melting and kneading the resin composition, because the temperature depends, for example, on physical properties (melting point, weight average molecular weight, etc.) of the thermoplastic resin which is a raw material and on a type of an additive used. In a case where a polyhydroxyalkanoic acid-based resin, which will be described later, is used as the thermoplastic resin, the temperature at the time of melting and kneading the resin composition is set such that, for example, the molten resin composition extruded from the annular die 11 is set preferably at 155° C. to 175° C. and more preferably at 165° C. to 173° C. In a case where composition temperature is not higher than 155° C., an unmelted substance of the polyhydroxyalkanoic acid-based resin may be generated. On the other hand, in a case where the composition temperature is not lower than 175° C., the polyhydroxyalkanoic acid-based resin may thermally decompose.

In the cooling step, the molten resin tube P extruded from the annular die 11 is cooled. In the introduction step in the cooling step, the molten resin tube P is introduced into the preliminary water tank 20 to which cooling water is continuously supplied and then into the vacuum water tank 30 which is connected to the preliminary water tank 20. In the introduction step, the molten resin tube P is introduced into the vacuum water tank 30 from the inlet 31a by vacuum suction together with the cooling water in the preliminary water tank 20. When the molten resin tube P is introduced into the vacuum water tank 30 by vacuum suction, the molten resin tube P is subjected to sizing by the sizing die 23 such that a bore diameter of the molten resin tube P is reduced. This leads to improvement of the degree of true circle of the molten resin tube P (sizing effect).

Further, in the suppression step, the jig 40 is installed in the preliminary water tank 20, and the jig 40 suppresses direct hit of a flow of the cooling water on the molten resin tube P. This can prevent unsteady movement of the molten resin tube P in the preliminary water tank 20, so that the stability of continuous extrusion of the molten resin tube P is improved. Further, the position where the molten resin tube P enters the sizing die 23 is stabilized, and thus the sizing effect of the molten resin tube P is improved.

Further, in the tubular-molded-body production method in accordance with the present embodiment, the jig 40 preferably has a passage part 41 for guiding the molten resin tube P to the vacuum water tank 30. Further, in the suppression step, it is preferable that the jig 40 be installed such that the side wall portion 41a of the passage part 41 receives the flow of the cooling water. This makes it possible to further prevent unsteady movement of the molten resin tube P in the preliminary water tank 20.

In the tubular-molded-body production method in accordance with the present embodiment, an inflow amount of the cooling water that is supplied to the preliminary water tank 20 is not particularly limited as long as the molten resin tube P can be preliminarily cooled. For example, in case a where a polyhydroxyalkanoic acid-based resin, which will be described later, is used as a raw material for the molten resin tube P, it is preferable that the inflow amount of the cooling water supplied to the preliminary water tank 20 be not less than 30 mL/sec and more preferably not less than 60 mL/sec. The upper limit of the inflow amount of the cooling water supplied to the preliminary water tank 20 is not particularly limited, but is preferably not more than 150 mL/sec and more preferably not more than 100 mL/sec. In particular, in a case where a polyhydroxyalkanoic acid-based resin, which will be described later, is used as a raw material for the molten resin tube P, the molten resin tube P is likely to deform since the polyhydroxyalkanoic acid-based resin has a slow solidification speed. Accordingly, the inflow amount of the cooling water that is supplied to the preliminary water tank 20 becomes a large amount as in the above numerical range. In a state in which the inflow amount of the cooling water is large as described above, it is difficult to suppress, only by setting a discharge direction of the cooling water of the supply section 22 such that the discharge direction is along an axis of the molten resin tube P, the flow of the cooling water to the molten resin tube P to an extent that the unsteady movement of the molten resin tube P can be suppressed. According to the tubular-molded-body production method in accordance with the present embodiment, even in a case where the inflow amount of the cooling water supplied to the preliminary water tank 20 is large as in the above numerical range, the jig 40 is installed in the suppression step and thus, it is possible to prevent unsteady movement of the molten resin tube P in the preliminary water tank 20.

Note that the cooling water supplied to the preliminary water tank 20 may be at any temperature at which the molten resin tube P can be preliminarily cooled. The temperature of the cooling water can be set, as appropriate, in accordance with a raw material of the molten resin tube P. For example, in a case where a polyhydroxyalkanoic acid-based resin, which will be described later, is used as a raw material for the molten resin tube P, it is preferable that the temperature of the cooling water be in a range of 5° C. to 60° C., and more preferably in the range of 20° C. to 60° C.

(Resin Composition Used in Tubular-Molded-Body Production Method in Accordance with Present Embodiment)

A resin composition that is used in the tubular-molded-body production method in accordance with the present embodiment, that is, a resin composition constituting a raw material of the molten resin tube P contains a thermoplastic resin. The thermoplastic resin is not particularly limited. Preferred examples of thermoplastic resin include not only general-purpose resins such as polypropylene, polyethylene, polyvinyl chloride, polyvinyl acetate, polyacetal, polycarbonate, polyamide, acrylonitrile, butadiene, polystyrene, and acrylic polymers but also biodegradable resins such as P3HA-based resin, polylactic acid, polyglycol acid, polybutylene succinate, polybutylene succinate adipate, polybutylene adipate terephthalate, polybutylene succinate terephthalate, and polycaprolactone. It is possible to use one type of the above thermoplastic resins alone or to use two or more types of the thermoplastic resins in combination.

In particular, the resin composition preferably contains an aliphatic polyester-based resin.

Further, the aliphatic polyester-based resin is preferably a poly(3-hydroxyalkanoate)-based resin (hereinafter, also referred to as P3HA-based resin). In the present specification, the “P3HA-based resin” refers to a polyhydroxyalkanoate, which includes, as a repeating unit, a 3-hydroxyalkanoic acid repeating unit represented by the general formula: (—CHR—CH₂—CO—O—) (where R is an alkyl group represented by CₙH₂ₙ₊₁, and n is an integer of 1 to 15).

More specifically, the P3HA-based resin preferably includes a 3-hydroxybutyrate (3HB) unit. It is preferable that the P3HA-based resin including a 3HB unit be selected from the group consisting of poly(3-hydroxybutyrate) (P3HB), poly(3-hydroxybutyrate-co-3-hydroxyvalerate) (P3HB3HV), poly(3-hydroxybutyrate-co-3-hydroxyhexanoate) (P3HB3HH), poly(3-hydroxybutyrate-co-3-hydroxyvalerate-co-3-hydroxyhexanoate) (P3HB3HV3HH), poly(3-hydroxybutyrate-co-4-hydroxybutyrate) (P3HB4HB), poly(3-hydroxybutyrate-co-3-hydroxyoctanoate), and poly(3-hydroxybutyrate-co-3-hydroxydecanoate). It is possible to include only one type of the above P3HA-based resins or to include two or more types of the P3HA-based resins in combination.

The P3HA-based resin is preferably a P3HA-based resin (microbially produced P3HA-based resin) which is produced by microorganisms. The microbially produced P3HA-based resin usually consists only of a polyhydroxyalkanoate monomer unit of the D-form (R-form). Among microbially produced P3HA-based resins, P3HB, P3HB3HH, P3HB3HV, P3HB3HV3HH, and P3HB4HB are preferable, and P3HB, P3HB3HH, P3HB3HV, and P3HB4HB are more preferable, from the viewpoint of ease of industrial production.

The P3HA-based resin can also be produced by a method disclosed, for example, in International Publication No. WO 2010/013483. Commercially available products of the P3HA-based resin include, for example, “KANEKA Biodegradable Polymer PHBH (registered trademark)” of Kaneka Corporation.

Further, the P3HA-based resin includes at least one kind of copolymer of a 3HB unit and another hydroxyalkanoate unit, and a composition ratio of the above 3-hydroxybutyrate unit in the poly(3-hydroxyalkanoate)-based resin is in a range of 65.0 mol % to 99.0 mol %, preferably in a range of 68.0 mol % to 98.5 mol %, more preferably in a range of 70.0 mol % to 98.5 mol %, and even more preferably in a range of 70.0 mol % to 98.0 mol %, with respect to all the repeating units (100 mol %).

In a case where the composition ratio of the 3HB repeating unit is not less than 90.0 mol %, the P3HA-based resin is likely to have further improved rigidity, and a faster crystallization speed, and reduced burrs, so that productivity is likely to improve. On the other hand, in a case where the composition ratio of the 3HB repeating unit is not more than 99.0 mol %, the melting point is less than the thermal decomposition temperature, so that stable and continuous production becomes possible. Note that a monomer composition ratio of the P3HA-based resin can be measured by gas chromatography or the like (for example, see International Publication No. WO 2014/020838).

The molecular weight of the P3HA-based resin is not particularly limited as long as substantially sufficient physical properties for an intended application is exhibited. A range of the weight average molecular weight of the P3HA-based resin is preferably from 100,000 to 1,000,000, more preferably from 150,000 to 700,000, even more preferably from 200,000 to 500,000, and particularly preferably from 250,000 to 450,000. In a case where the weight average molecular weight is not less than 100,000, moderate mechanical strength is obtained. Further, when the molecular weight is not more than 1,000,000, an increase in melt viscosity can be suppressed, and thus moldability is excellent.

The weight average molecular weight can be determined, as a polystyrene equivalent molecular weight, by a measurement method in which: gel permeation chromatography (GPC) (“Shodex GPC-101” manufactured by Showa Denko K.K.) is used; polystyrene gel (“Shodex K-804” manufactured by Showa Denko K.K.) is used in a column; and chloroform is used as a mobile phase. At this time, a calibration curve is prepared with use of respective polystyrenes having weight average molecular weights of: 31,400; 197,000; 668,000; and 1,920,000. As the column in the GPC, a column suitable for measuring the molecular weight may be used.

Further, the resin composition may include an additive that can be used together with the thermoplastic resin within a range that does not hinder the effect of the present invention. Examples of the additive include: inorganic fillers such as talc, calcium carbonate, mica, and silica; colorants such as pigments and dyes; odor absorbing agents such as activated carbon and zeolite; perfumes such as vanillin and dextrin; plasticizers; oxidation inhibitors; antioxidants; weather resistance improvers; ultraviolet; crystal nucleating agents; lubricants; mold release agents; water repellent agents; antibacterial agents; and slidability improving agents. It is possible to include only one type of the above additives or to include two or more of the above additives in combination. The content of these additives can be set, as appropriate, by a person skilled in the art according to the purpose of use.

According to the present embodiment, in a case where the P3HA-based resin is used as a raw material of the tubular molded body, marine contamination due to disposal can be suppressed. This makes it possible to contribute to achieving, for example, Sustainable Development Goals (SDGs) such as Goal 12 “Ensure sustainable consumption and production patterns” and Goal 14 “Conserve and sustainably use the oceans, seas and marine resources for sustainable development”.

Further, the tubular molded body produced by the production method in accordance with the present embodiment can be any tubular molded body which can be produced by extrusion molding. Examples of such a tubular molded body include straws, pipes, and hollow fibers, and straws are suitable.

The present invention is not limited to the embodiments, but can be altered by a skilled person in the art within the scope of the claims. The present invention also encompasses, in its technical scope, any embodiment derived by combining technical means disclosed in differing embodiments.

In other words, an embodiment of the present invention is as follows.

<1> A tubular-molded-body production method, including the steps of:
extruding a molten resin composition from an annular die 11 and forming a molten resin tube P; and
cooling the molten resin tube P,
the step of cooling including the steps of:
introducing the molten resin tube P into a preliminary water tank 20 to which cooling water is continuously supplied and then into a vacuum water tank 30 which is connected to the preliminary water tank 20, and
suppressing, with use of a jig 40, direct hit of a flow of the cooling water on the molten resin tube P by installing the jig 40 in the preliminary water tank 20.

<2> The tubular-molded-body production method according to <1>, wherein:
the jig 40 has a passage part 41 for guiding the molten resin tube P to the vacuum water tank 30; and
in the step of suppressing, the jig 40 is installed such that a side wall portion 41a of the passage part 41 receives the flow of the cooling water.

<3> The tubular-molded-body production method according to <2>, wherein the jig 40 has a trough shape.

<4> The tubular-molded-body production method according to any one of <1> to <3>, wherein the cooling water is supplied to the preliminary water tank 20 at an inflow amount of not less than 30 mL/sec.

<5> The tubular-molded-body production method according to any one of <1> to <4>, wherein the resin composition constituting a raw material of the molten resin tube P contains a poly(3-hydroxyalkanoate)-based resin.

<6> The tubular-molded-body production method according to <5>, wherein the poly(3-hydroxyalkanoate)-based resin is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-3-hydroxyvalerate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

<7> A tubular-molded-body production device including:
an extrusion section (melt extruder 10) that has an annular die 11 for extruding a molten resin composition into a tubular shape; and
a cooling section C that cools the molten resin tube P extruded from the annular die 11,
the cooling section C including a preliminary water tank 20 and a vacuum water tank 30 connected to the preliminary water tank 20, and being configured such that the molten resin tube P is introduced into the preliminary water tank 20 and then into the vacuum water tank 30,
the preliminary water tank 20 including a supply section 22, 24 that continuously supplies cooling water into the preliminary water tank 20, and
the preliminary water tank 20 being provided therein with a jig 40, and suppressing, with use of the jig 40, direct hit of a flow of the cooling water from the supply section 22, 24 on the molten resin tube P.

<8> The tubular-molded-body production device according to <7>, wherein:
the jig 40 has a passage part 41 for guiding the molten resin tube P to the vacuum water tank 30; and
the passage part 41 includes a side wall portion 41a that receives the flow of the cooling water from the supply section 22.

<9> The tubular-molded-body production device according to <8>, wherein the jig 40 has a trough shape.

### EXAMPLES

The following description will discuss embodiments of the present invention in further detail on the basis of Examples. Note, however, that the present invention is not limited to the Examples.

Substances used in the Examples and Comparative Examples are described below.

[Poly(3-hydroxyalkanoate)-based Resin]

### Copolymer (A):

P3HB3HH-30:P3HB3HH (average content ratio 3HB/3HH=70.5/29.5 (mol %/mol %), weight average molecular weight of 0.64 million g/mol),
which was produced in accordance with a method described in example 9 of International Publication No. WO 2019/142845.

### Copolymer (B):

P3HB3HH-11H:P3HB3HH (KANEKA Biodegradable Polymer PHBH (registered trademark)) (average content ratio 3HB/3HH=89.0/11.0 (mol %/mol %), weight average molecular weight of 0.75 million g/mol),
which was produced in accordance with a method described in International Publication No. WO 2008/010296.
   Poly(3-hydroxybutyrate) (C1):
PHB: poly(3-hydroxybutyrate) (weight average molecular weight of 0.30 g/mol),
which was produced in accordance with a method described in Comparative Example 1 of International Publication No. WO 2004/041936.

### Copolymer (C2):

P3HB3HH-3:P3HB3HH (average content ratio 3HB/3HH=97.1/2.9 (mol %/mol %), weight average molecular weight of 0.3 million g/mol),
which was produced in accordance with a method described in example 2 of International Publication No. WO 2019/142845.
P3HB3HH-6:P3HB3HH (average content ratio 3HB/3HH=94/6 (mol %/mol %), weight average molecular weight of 0.50 million g/mol),
which was produced in accordance with a method described in International Publication No. WO 2008/010296.

### Copolymer (C3):

P3HB3HH-13:P3HB3HH (KANEKA Biodegradable Polymer PHBH (registered trademark)) (average content ratio 3HB/3HH=87.1/12.9 (mol %/mol %), weight average molecular weight of 0.33 million g/mol)

### [Additives]

Additive-1: Behenamide (BNT-22H, manufactured by Nippon Fine Chemical Co., Ltd.)
Additive-2: Erucamide (NEUTRON-S, manufactured by Nippon Fine Chemical Co., Ltd.)

### [Plasticizer]

Plasticizer: Glycerin diacetomonolaurate (BIOCIZER, manufactured by Riken Vitamin Co., Ltd.)

Evaluation methods that are carried out in Examples and Comparative Examples are described below.

### [Evaluation of Unsteady Movement]

During tube molding, a position of a molten resin tube, which has been extruded from an annular die, in a preliminary water tank was visually checked. Then, in a case where the molten resin tube moved by not less than 2 mm in a direction orthogonal to an extrusion direction, the unsteady movement was evaluated as “unsteady movement occurred (present)”. On the other hand, in a case where the molten resin tube moved by less than 2 mm, the unsteady movement was evaluated as “no unsteady movement occurred (absent)”.

### [Evaluation of Stable Moldability]

Tube molding was performed. In a case where the tube molding could be continuously performed for not less than 10 minutes, the stable moldability was evaluated as “good”. On the other hand, in a case where the tube molding stopped within less than 10 minutes, the molding stability was evaluated as “poor”.

### Example 1

Mixed and blended were 0.494 kg of P3HB3HH-30, 0.094 kg of P3HB3HH-11H, 0.248 kg of PHB, 0.87 kg of P3HB3HH-3, 0.292 kg of P3HB3HH-13, 20 g of Additive-1, and 10 g of Additive-2.

A resulting blend was melt-extruded by a φ26 mm co-rotating twin-screw extruder. A cylinder temperature of the co-rotating twin-screw extruder and a die temperature were each set at 150° C. An extruded strand-shaped resin material was passed through a water tank filled with warm water at 40° C. and cut by a pelletizer, so that resin composition pellets were obtained.

Thereafter, the resin composition pellets were used as a raw material, and tube molding was performed by a φ50 mm single screw extruder. An annular die (having an outer diameter of 15 mm and an inner diameter of 13.5 mm) was attached to the extruder, and a cylinder temperature and a die temperature were each set at 160° C. A water tank was filled with warm water at 40° C. A position of the water tank was adjusted so that the distance from the die to an inlet of the water tank was 50 mm. The jig illustrated in FIG. 3 was installed in the preliminary water tank while a flow rate (referred to as “water flow rate” in Table 1) of cooling water to be supplied to the preliminary water tank was set to 30 ml/sec.

The rotational frequency of a screw of the extruder was adjusted so that a discharge rate of the extruder was 10 kg/hour, and a haul-off speed of a haul-off device was set to 10 m/min. Thereafter, a molten resin tube was hauled off. After waiting for 5 minutes for stable haul-off, evaluation of unsteady movement and evaluation of extrusion stability were carried out.

### Examples 2 and 3 and Comparative Example 1

Except for the flow rate of the cooling water supplied to the preliminary water tank and whether or not the jig was installed, tube molding was performed in the same manner as in Example 1, and then, evaluation was carried out in the same manner as in Example 1. Table 1 shows results that are brought together.

TABLE 1

| | | Water flow | | |
|---|---|---|---|---|
| | Whether or not | rate | Unsteady | Stable |
| | jig was installed | [mL/sec.] | movement | moldability |
| Example 1 | Installed | 30 | Absent | Good |
| Example 2 | Installed | 50 | Absent | Good |
| Example 3 | Installed | 70 | Absent | Good |
| Comparative | Not installed | 30 | Present | Poor |
| Example 1 | | | | |

It is clear from Table 1 that in Examples 1 to 3 in which the jig was installed in the preliminary water tank, unsteady movement of the molten resin tube was suppressed and stable moldability (stability of continuous extrusion) of the molten resin tube could be improved.

### INDUSTRIAL APPLICABILITY

An aspect of the present invention is applicable to a field of extrusion molding of a tubular molded body.

### REFERENCE SIGNS LIST

10 melt extruder (extrusion section)
11 annular die
20 preliminary water tank
22, 24 supply section
30 vacuum water tank
40 jig
41 passage part
41a side wall portion
41b bottom wall portion
100 production device
P molten resin tube

1. A tubular-molded-body production method, comprising the steps of:
extruding a molten resin composition from an annular die and forming a molten resin tube; and
cooling the molten resin tube,
the step of cooling including the steps of:
introducing the molten resin tube into a preliminary water tank to which cooling water is continuously supplied and then into a vacuum water tank which is connected to the preliminary water tank, and
suppressing, with use of a jig, direct hit of a flow of the cooling water on the molten resin tube by installing the jig in the preliminary water tank.

2. The tubular-molded-body production method according to claim 1, wherein:
the jig has a passage part for guiding the molten resin tube to the vacuum water tank; and
in the step of suppressing, the jig is installed such that a side wall portion of the passage part receives the flow of the cooling water.

3. The tubular-molded-body production method according to claim 2, wherein the jig has a trough shape.

4. The tubular-molded-body production method according to claim 1, wherein the cooling water is supplied to the preliminary water tank at an inflow amount of not less than 30 mL/sec.

5. The tubular-molded-body production method according to claim 1, wherein the resin composition constituting a raw material of the molten resin tube contains a poly(3-hydroxyalkanoate)-based resin.

6. The tubular-molded-body production method according to claim 5, wherein the poly(3-hydroxyalkanoate)-based resin is selected from the group consisting of poly(3-hydroxybutyrate), poly(3-hydroxybutyrate-co-3-hydroxyvalerate), poly(3-hydroxybutyrate-co-3-hydroxyhexanoate), poly(3-hydroxybutyrate-co-3-hydroxyvalerate-co-3-hydroxyhexanoate), poly(3-hydroxybutyrate-co-4-hydroxybutyrate), poly(3-hydroxybutyrate-co-3-hydroxyoctanoate), and poly(3-hydroxybutyrate-co-3-hydroxydecanoate).

7. A tubular-molded-body production device, comprising:
an extrusion section that has an annular die for extruding a molten resin composition into a tubular shape; and
a cooling section that cools the molten resin tube extruded from the annular die,
the cooling section including a preliminary water tank and a vacuum water tank connected to the preliminary water tank, and being configured such that the molten resin tube is introduced into the preliminary water tank and then into the vacuum water tank,
the preliminary water tank including a supply section that continuously supplies cooling water into the preliminary water tank, and
the preliminary water tank being provided therein a jig, and suppressing, with use of the jig, direct hit of a flow of the cooling water from the supply section on the molten resin tube.

8. The tubular-molded-body production device according to claim 7, wherein:
the jig has a passage part for guiding the molten resin tube to the vacuum water tank; and
the passage part includes a side wall portion that receives the flow of the cooling water from the supply section.

9. The tubular-molded-body production device according to claim 8, wherein the jig has a trough shape.
